(19) United States
(12) Patent Application Publication
(10) Pub. No.: US 2023/0237420 A1
(43) Pub. Date: Jul. 27, 2023

(54) BUSINESS DATA COURSE MANAGEMENT SYSTEM AND BUSINESS DATA COURSE MANAGEMENT METHOD THEREOF

(71) Applicants: Digiwin Software Co., Ltd, Shanghai (CN); DATA SYSTEMS CONSULTING CO., LTD., New Taipei City (TW)

(72) Inventors: Yihai Gao, Shanghai (CN); Guoxin Sun, Shanghai (CN)

(73) Assignees: Digiwin Software Co., Ltd, Shanghai (CN); DATA SYSTEMS CONSULTING CO., LTD., New Taipei City (TW)

(21) Appl. No.: 17/709,433

(22) Filed: Mar. 31, 2022

(30) Foreign Application Priority Data
Jan. 26, 2022 (CN) 202210092121.8

(51) Int. Cl. G06Q 10/06; G06F 9/54

(52) U.S. Cl. CPC G06Q 10/067; G06F 9/54

(57) ABSTRACT

A business data course management system and a business data course management method are provided. An electronic device sends a first calling information corresponding to the first application programming interface (API) to a business data course management server. According to a first API identifier corresponding to the first API, the business data course management server loads a corresponding first extraction rule to extract a first upstream business data type information, a first upstream business data identifier, a first downstream business data type information, and a first downstream business data type identifier from the first calling information according to the first extraction rule. The business data course management server creates a first upstream business data record and creates a first downstream business data record.

### CROSS-REFERENCE TO RELATED APPLICATION

This application claims the priority benefit of China patent application no. 202210092121.8, filed on Jan. 26, 2022. The entirety of the above-mentioned patent application is hereby incorporated by reference herein and made a part of this specification.

### BACKGROUND

### Technical Field

The disclosure relates to a data management technology; more particularly, the disclosure relates to a business data course management system and a business data course management method.

### Description of Related Art

A large number of modern enterprises model their business processes via business process management (BPM) to assist the operation and management of the enterprises. However, conventional business process management is relatively rigid, and generally only current business data and business data status may be applied as a basis for determination of branch correlations. Hence, how to record relevant operations (hereinafter referred to as data courses) which have been performed on the business data and provide corresponding search methods for the determination of branch correlations is one of the important research topics in the pertinent field.

### SUMMARY

The disclosure provides a business data course management system and a business data course management method which may be applied to create a business data course and effectively search the business data course with ease.

According to an embodiment of the disclosure, a business data course management system including a business data course management server and an electronic device is provided. The electronic device is connected to the business data course management server. After the electronic device completes calling a first application programming interface (API), the electronic device sends a first calling information corresponding to the first API to the business data course management server, and according to a first API identifier corresponding to the first API, the business data course management server loads a corresponding first extraction rule, so as to extract a first upstream business data type information, a first upstream business data identifier, a first downstream business data type information, and a first downstream business data type identifier from the first calling information according to the first extraction rule. The business data course management server creates a first upstream business data record according to the first upstream business data type information and the first upstream business data identifier and creates a first downstream business data record according to the first downstream business data type information and the first downstream business data type identifier.

According to an embodiment of the disclosure, a business data course management method including following steps is provided. After an electronic device completes calling a first API, a first calling information corresponding to the first API is sent to a business data course management server through the electronic device. According to a first API identifier corresponding to the first API, a corresponding first extraction rule is loaded through the business data course management server, so as to extract a first upstream business data type information, a first upstream business data identifier, a first downstream business data type information, and a first downstream business data type identifier from the first calling information according to the first extraction rule. A first upstream business data record is created according to the first upstream business data type information and the first upstream business data identifier through the business data course management server, and a first downstream business data record is created according to the first downstream business data type information and the first downstream business data type identifier through the business data course management server.

In view of the above, the business data course management system and the business data course management method provided in one or more embodiments of the disclosure are capable of effectively creating a corresponding business data course according to a calling result of each API service operated by a user through a specific manner of editing the business data course, so as to conveniently search and use the business data course.

To make the above more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic view of a business data course management system according to an embodiment of the disclosure.

FIG. 2 is a flowchart of a business data course management method according to an embodiment of the disclosure.

FIG. 3 is a flowchart of a business data course management method according to another embodiment of the disclosure.

FIG. 4 is a flowchart of calling an API according to an embodiment of the disclosure.

FIG. 5 is a schematic view of a business data record according to an embodiment of the disclosure.

FIG. 6 is a flowchart of searching a business data course according to an embodiment of the disclosure.

### DESCRIPTION OF THE EMBODIMENTS

Reference will now be made in detail to exemplary embodiments of the disclosure, examples of which are illustrated in the accompanying drawings. Wherever possible, the same reference numerals are used in the drawings and the description to refer to the same or similar parts.

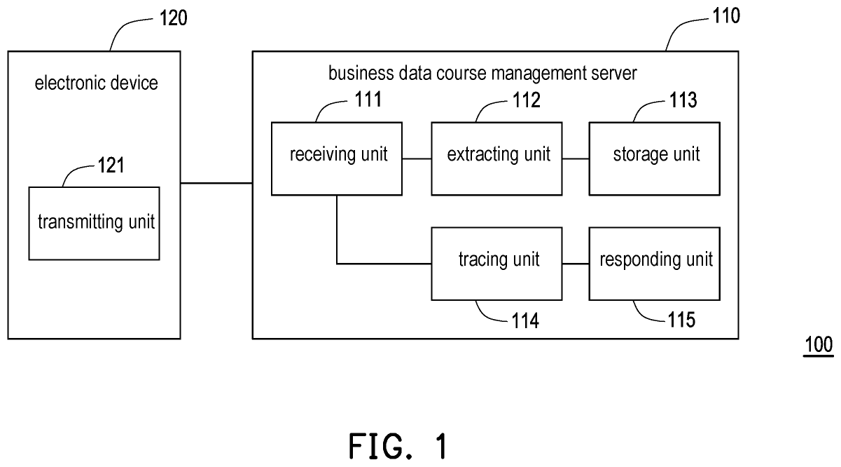

FIG. 1 is a schematic view of a business data course management system according to an embodiment of the disclosure. With reference to FIG. 1, a business data course management system 100 includes a business data course management server 110 and an electronic device 120. The business data course management server 110 includes a receiving unit 111, an extracting unit 112, a storage unit 113, a tracing unit 114, and a responding unit 115. The receiving unit 111 is coupled to the extracting unit 112 and the storage unit 113. The extracting unit 112 is coupled to the storage unit 113. The tracing unit 114 is coupled to the responding unit 115. The electronic device 120 includes a transmitting unit 121. In this embodiment, the electronic device 120 may be, for instance, a personal computer (PC), a tablet, a server, or any other computing device capable of performing computing functions, and the electronic device 120 is connected to the business data course management server 110. In this embodiment, the receiving unit 111, the extracting unit 112, the storage unit 113, the tracing unit 114, the responding unit 115, and the transmitting unit 121 may be implemented in form of corresponding software and/or programs and corresponding data transmission interfaces and/or data coursing modules, respectively, so as to perform respective functions.

In this embodiment, a user may call an API by operating the electronic device 120; after that, the electronic device 120 may send the calling result (calling information) to the business data course management server 110, so that the business data course management server 110 may automatically create a relevant business data course according to the calling result (the calling information). Thereby, when the user intends to search the relevant business data course by operating the electronic device 120, the business data course management server 110 may, according to the previously created relevant business data course, effectively and rapidly perform a data course search function. In addition, the API may be, for instance, a cloud business application service provided by the business data course management server 110 or provided by other cloud servers, which should however not be construed as a limitation in the disclosure.

In this embodiment, the business data course management server 110 and the electronic device 120 may respectively include a processing unit and a storage unit. The processing unit may, for instance, include a central processing unit (CPU) or any other programmable general or special purpose microprocessor, digital signal processor (DSP), application specific integrated circuit (ASIC), programmable logic device (PLD), another similar processing circuit, or a combination thereof. The storage unit may be a memory, such as a non-volatile memory (NVM). The storage unit may store relevant programs, units, modules, or algorithms for the processing unit to access and then execute and achieve relevant functions and operations provided in one or more embodiments of the disclosure.

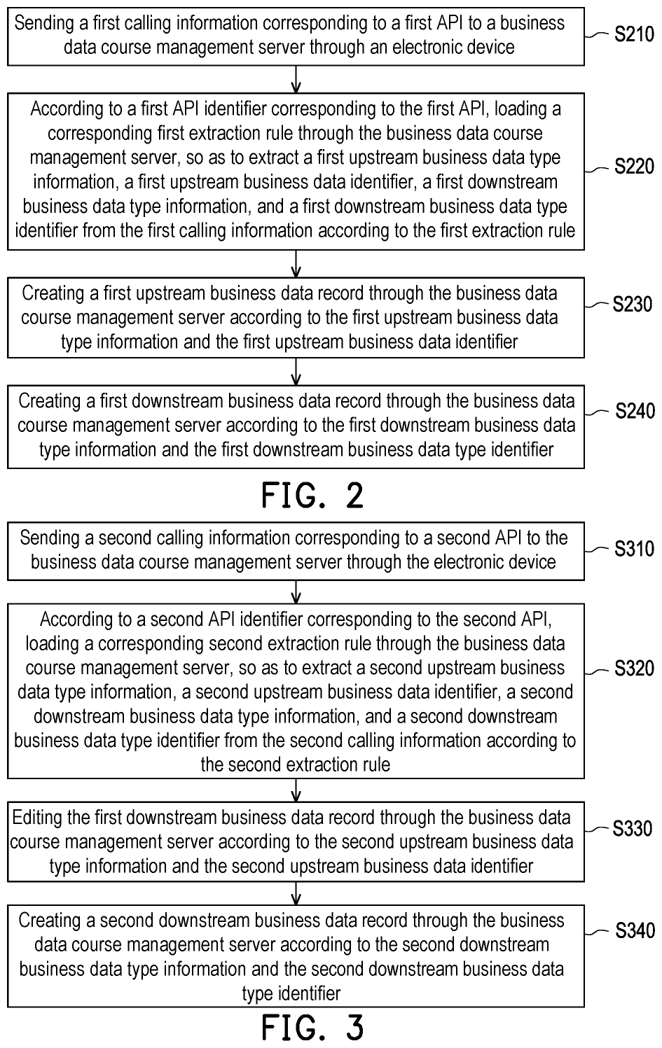

FIG. 2 is a flowchart of a business data course management method according to an embodiment of the disclosure. With reference to FIG. 1 and FIG. 2, the business data course management system 100 may perform following steps S210-S240 to effectively create a business data course. In this embodiment, the user may operate the electronic device 120 to call a first API first to obtain a first calling information (calling result). The first calling information includes a first request information and a first response information. In step S210, the transmitting unit 121 of the electronic device 120 may send the first calling information corresponding to the first API to the business data course management server 110. The receiving unit 111 of the business data course management server 110 may receive the first calling information. In step S220, the extracting unit 112 of the business data course management server 110 may, according to a first API identifier corresponding to the first API, load a corresponding first extraction rule, so as to extract a first upstream business data type information, a first upstream business data identifier, a first downstream business data type information, and a first downstream business data type identifier from the first calling information according to the first extraction rule. The API identifier may be a “purchase.order.create” identifier or a “purchase.order.change” identifier, which should however not be construed as a limitation in the disclosure. In this embodiment, the extraction rule is set according to a pre-defined algorithm and is adapted to describe how to extract required data from the calling information of the API. The algorithm may be, for instance, JavaScript Object Notation (JSON) algorithm, which should however not be construed as a limitation in the disclosure.

In this embodiment, the extracting unit 112 may analyze the first request information and the first response information in the first calling information to extract the required information. Such information includes the first upstream business data type information, the first upstream business data identifier, the first downstream business data type information, and the first downstream business data type identifier. The extraction rule describes the location of such information in the first request information and/or the first response information. In step S230, the business data course management server 110 may create a first upstream business data record according to the first upstream business data type information and the first upstream business data identifier. In step S240, the storage unit 113 of the business data course management server 110 may create a first downstream business data record according to the first downstream business data type information and the first downstream business data type identifier. Therefore, the business data course management server 110 provided in this embodiment may automatically create the first upstream business data record and the corresponding first downstream business data record according to the calling result of the first API for subsequent search of the business data course.

FIG. 3 is a flowchart of a business data course management method according to another embodiment of the disclosure. With reference to FIG. 1 and FIG. 3, the business data course management system 100 may perform following steps S310-S340 to continue the process of creating the business data course provided above. In this embodiment, the user may operate the electronic device 120 and then call a second API to obtain a second calling information (calling result). It is worth noting that the first API is associated with the second API, and there is an associated information between the first calling information and the second calling information. The second calling information includes a second request information and a second response information. In step S310, the electronic device 120 may send the second calling information corresponding to the second API to the business data course management server 110. The receiving unit 111 of the business data course management server 110 may receive the second calling information. In step S320, the extracting unit 112 of the business data course management server 110 may, according to a second API identifier corresponding to the second API, load a corresponding second extraction rule, so as to extract a second upstream business data type information, a second upstream business data identifier, a second downstream business data type information, and a second downstream business data type identifier from the second calling information according to the second extraction rule. The extracting unit 112 may analyze the second request information and the second response information in the second calling information to extract the required information. Such information includes the second upstream business data type information, the second upstream business data identifier, the second downstream business data type information, and the second downstream business data type identifier. The extraction rule describes the location of such information in the second request information and/or the second response information. In step S330, the business data course management server 110 may edit the first downstream business data record according to the second upstream business data type information and the second upstream business data identifier. In step S340, the storage unit 113 of the business data course management server 110 creates a second downstream business data record according to the second downstream business data type information and the second downstream business data type identifier. Therefore, the business data course management server 110 provided in this embodiment may automatically edit the previously stored first downstream business data record according to the calling result of the second API and create the corresponding second downstream business data record for effectively expanding the business data course and for conducting subsequent search of the business data course.

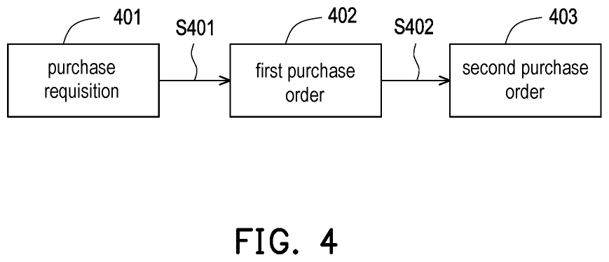

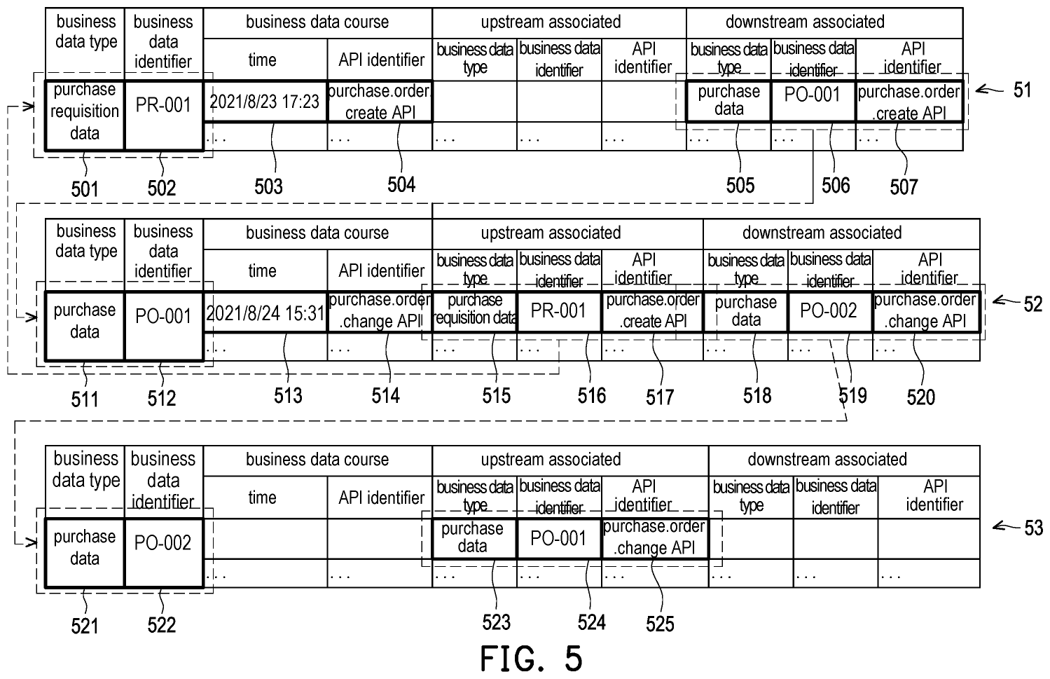

FIG. 4 is a flowchart of calling an API according to an embodiment of the disclosure. FIG. 5 is a schematic view of a business data record according to an embodiment of the disclosure. With reference to FIG. 1, FIG. 4, and FIG. 5, for instance, first, in step S401, the user may operate the electronic device 110 to execute a purchase.order.create API service of creating a purchase order based on a purchase requisition, so as to generate a first purchase order 402 (the calling result) according to a purchase requisition 401. In this regard, the business data course management server 110 may create business data records 51 and 52 as shown in FIG. 5 according to the step S401. The extracting unit 112 of the business data course management server 110 may generate an (upstream) business data type information 501 (such as “purchase requisition data”) and an (upstream) business data identifier information 502 (such as “PR-001”) in the business data record 51 according to the corresponding extraction rules and generate a (downstream) business data type information 511 (such as “purchase data”) and a (downstream) business data identifier information 512 (such as “PO-001”) in the business data record 52. Besides, the business data course management server 110 further records the (downstream) associated information and a calling history of the purchase.order.create API service into the business data record 51, such as course information 505-507 (such as “purchase data”, “PO-001”, and “purchase.order.create API) corresponding to business data types in multiple fields of the downstream associated information in the business data record 51 as shown in FIG. 5. In addition, the business data course management server 110 further records an (upstream) associated information into the business data record 52, such as course information 515-517 (e.g., “purchase requisition data”, “PR-001”, and “purchase.order.create API”) corresponding to business data types in multiple fields of the upstream associated information in the business data record 52 as shown in FIG. 5, for instance. In addition, the business data course management server 110 may further record a calling of a time information 503 and an API identifier 504 (e.g., identifying “purchase.order.create API”) of creating a purchase order based on the purchase requisition in a time field and an API identifier field of a business data course field in the business data record 51. Thereby, the business data course management server 110 may effectively create a business data course of the API service in association with creating the purchase order based on the purchase requisition.

Next, in step S402, the user may operate the electronic device 110 to execute the purchase.order.change API service, so as to generate a second purchase order 403 (calling result) according to the purchase requisition 401. In this regard, the business data course management server 110 may create a business data record 53 as shown in FIG. 5 according to the step S402 and update the content of the business data record 52. The extracting unit 112 of the business data course management server 110 may check the (upstream) business data type information 511 (such as “purchase data”) and the (upstream) business data identifier information 512 (such as “PO-001”) in the business data record 52 according to the corresponding extraction rule and generate the (downstream) business data type information 521 (such as “purchase data”) and the (downstream) business data identifier information 522 (such as “PO-002”) in the business data record 53. Besides, the business data course management server 110 further records the (downstream) associated information and the calling history and of the purchase.order.change API service into the business data record 52, such as course information 518-520 (e.g., “purchase data”, “PO-002”, and “purchase.order.change API”) corresponding to business data types in multiple fields of the downstream associated information in the business data record 52 as shown in FIG. 5, for instance. In addition, the business data course management server 110 further records the (upstream) associated information into the business data record 53, such as course information 523-525 (e.g., “purchase requisition data”, “PO-001”, and “purchase.order.change API”). Moreover, the business data course management server 110 may further record a calling of a time information 513 and an API identifier 514 (e.g., identifying “purchase.order.change API”) of changing the purchase order in the time field and the API identifier field of the business data course field in the business data record 52. Thereby, the business data course management server 110 may efficiently create a business data course of the API service in association with performing the purchase order change. The business data records 51-53 may be combined as a data set of business data records, which is convenient for subsequent course search. More importantly, the business data course management server 110 may effectively combine the business data records respectively generated according to the calling results of the associated API services, so as to effectively expand the business data course and ensure that the data course is not interrupted.

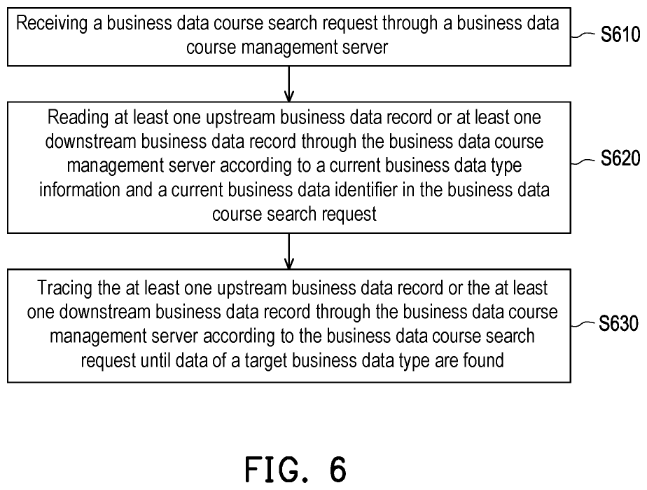

FIG. 6 is a flowchart of searching a business data course according to an embodiment of the disclosure. With reference to FIG. 1 and FIG. 6, after the business data course provided in the embodiment depicted in FIG. 3 and FIG. 4 is created, the user may operate the electronic device 120 to send a business data course search request to the business data course management system 100, so that the business data course management system 100 may perform following steps S610-S630 to search the business data course. In step S610, the business data course management server 110 may receive the business data course search request. The business data course search request further includes a target business data type information and a tracing direction information. In step S620, the business data course management server 110 may read at least one upstream business data record or at least one downstream business data record according to a current business data type information and a current business data identifier in the business data course search request. In step S630, the business data course management server 110 may trace the at least one upstream business data record or the at least one downstream business data record according to the business data course search request until data of a target business data type are found. In this embodiment, the business data course management server 110 may trace and compare the at least one upstream business data record or the at least one downstream business data record according to the target business data type information and the tracing direction information, so as to keep tracing the chain of business data course created according to the previous embodiments until the required data course is found.

For instance, in the exemplary FIG. 5, the business data course search request may include information associated with the current data type as “purchase data”, the business data identifier as “PO-002”, the target business data type as “purchase requisition data”, and the tracing direction as a back-tracing direction (e.g., a backward timeline), for instance. In this regard, the business data course management server 110 may extract the business data record 53 according to the current data type (“purchase data”) and the business data identifier (“PO-002”), search (trace) the business data record 52 corresponding to the upstream associated information of the business data record 53 according to the target business data type (“purchase requisition data”) and the tracing direction (the back-tracing direction), and determine whether the business data record 52 belongs to the same target business data type (“purchase requisition data”). If not, the business data course management server 110 may start comparing the upstream associated information of the business data record 52 to search (trace) the business data record 51 corresponding to the upstream associated information of the business data record 52. The business data course management server 110 may determine that the business data record 51 belongs to the same target business data type (“purchase requisition data”), and thus the business data course management server 110 may send the searched business data record 51 back to the electronic device 120 for the user's reference or use. As such, the business data course management system 100 provided in this embodiment may perform an efficient and unambiguous business data course search function.

To sum up, the business data course management system and business data course management method provided in one or more embodiments of the disclosure are capable of effectively creating the corresponding business data course according to the calling result of each API service operated by the user, and the business data course generated by the associated calling operations may be combined and linked to generate a data set of the business data courses. Thereby, the business data course management system and the business data course management method provided in one or more embodiments of the disclosure are capable of performing the efficient and convenient business data course search function for the user. The user may learn the corresponding data course through searching a certain step of the business course, whereby the subsequent business behavior may be determined efficiently and correctly. In other words, functions performed and effects achieved by the business data course management system and the business data course management method provided in one or more embodiments of the disclosure allow the execution of the business flow to be more flexible and to better comply with the actual business operations, while unnecessary business behaviors may be reduced.

It will be apparent to those skilled in the art that various modifications and variations can be made to the disclosed embodiments without departing from the scope or spirit of the disclosure. In view of the foregoing, it is intended that the disclosure covers modifications and variations provided they fall within the scope of the following claims and their equivalents.

What is claimed is:

1. A business data course management system, comprising:
a business data course management server; and
an electronic device, connected to the business data course management server,
wherein after the electronic device completes calling a first application programming interface, the electronic device sends a first calling information corresponding to the first application programming interface to the business data course management server, and according to a first application programming interface identifier corresponding to the first application programming interface, the business data course management server loads a corresponding first extraction rule, so as to extract a first upstream business data type information, a first upstream business data identifier, a first downstream business data type information, and a first downstream business data type identifier from the first calling information according to the first extraction rule,
wherein the business data course management server creates a first upstream business data record according to the first upstream business data type information and the first upstream business data identifier and creates a first downstream business data record according to the first downstream business data type information and the first downstream business data type identifier.

2. The business data course management system according to claim 1, wherein the first calling information comprises a first request information and a first response information.

3. The business data course management system according to claim 1, wherein the business data course management server records a first downstream associated information and a calling history of the first application programming interface into the first upstream business data record.

4. The business data course management system according to claim 1, wherein the business data course management server records a first upstream associated information into the first downstream business data record.

5. The business data course management system according to claim 1, wherein after the electronic device completes calling a second application programming interface, the electronic device sends a second calling information corresponding to the second application programming interface to the business data course management server, and according to a second application programming interface identifier corresponding to the second application programming interface, the business data course management server loads a corresponding second extraction rule, so as to extract a second upstream business data type information, a second upstream business data identifier, a second downstream business data type information, and a second downstream business data type identifier from the second calling information according to the second extraction rule, wherein the second upstream business data type information and the second upstream business data identifier are identical to the first downstream business data type information and the first downstream business data type identifier,
wherein the business data course management server edits the first downstream business data record according to the second upstream business data type information and the second upstream business data identifier, and the business data course management server creates a second downstream business data record according to the second downstream business data type information and the second downstream business data type identifier.

6. The business data course management system according to claim 5, wherein the second calling information comprises a second request information and a second response information.

7. The business data course management system according to claim 5, wherein the business data course management server records a second downstream associated information and a calling history of the second application programming interface into the first downstream business data record.

8. The business data course management system according to claim 5, wherein the business data course management server records a first upstream associated information into the second downstream business data record.

9. The business data course management system according to claim 1, wherein when the business data course management server receives a business data course search request, the business data course management server reads at least one upstream business data record or at least one downstream business data record according to a current business data type information and a current business data identifier in the business data course search request and traces the at least one upstream business data record or the at least one downstream business data record according to the business data course search request until data of a target business data type are found.

10. The business data course management system according to claim 9, wherein the business data course search request further comprises a target business data type information and a tracing direction information, and the business data course management server traces and compares the at least one upstream business data record or the at least one downstream business data record according to the target business data type information and the tracing direction information.

11. A business data course management method comprising:
after an electronic device completes calling a first application programming interface, sending through the electronic device a first calling information corresponding to the first application programming interface to a business data course management server;
according to a first application programming interface identifier corresponding to the first application programming interface, loading through the business data course management server a corresponding first extraction rule, so as to extract a first upstream business data type information, a first upstream business data identifier, a first downstream business data type information, and a first downstream business data type identifier from the first calling information according to the first extraction rule;
creating a first upstream business data record according to the first upstream business data type information and the first upstream business data identifier through the business data course management server; and
creating a first downstream business data record according to the first downstream business data type information and the first downstream business data type identifier through the business data course management server.

12. The business data course management method according to claim 11, wherein the first calling information comprises a first request information and a first response information.

13. The business data course management method according to claim 11, wherein a step of creating the first upstream business data record comprises:
recording a first downstream associated information and a calling history of the first application programming interface into the first upstream business data record through the business data course management server.

14. The business data course management method according to claim 11, wherein a step of creating the first downstream business data record comprises:
recording a first upstream associated information into the first downstream business data record through the business data course management server.

15. The business data course management method according to claim 11, further comprising:
after the electronic device completes calling a second application programming interface, sending a second calling information corresponding to the second application programming interface to the business data course management server through the electronic device;
according to a second application programming interface identifier corresponding to the second application programming interface, loading a corresponding second extraction rule through the business data course management server, so as to extract a second upstream business data type information, a second upstream business data identifier, a second downstream business data type information, and a second downstream business data type identifier from the second calling information according to the second extraction rule, wherein the second upstream business data type information and the second upstream business data identifier are identical to the first downstream business data type information and the first downstream business data type identifier;
editing the first downstream business data record through the business data course management server according to the second upstream business data type information and the second upstream business data identifier; and
creating a second downstream business data record through the business data course management server according to the second downstream business data type information and the second downstream business data type identifier.

16. The business data course management method according to claim 15, wherein the second calling information comprises a second request information and a second response information.

17. The business data course management method according to claim 15, wherein a step of editing the first downstream business data record comprises:
recording a second downstream associated information and a calling history of the second application programming interface into the first downstream business data record through the business data course management server.

18. The business data course management method according to claim 15, wherein a step of creating the second downstream business data record comprises:
recording a first upstream associated information into the second downstream business data record through the business data course management server.

19. The business data course management method according to claim 11, further comprising:
receiving a business data course search request through the business data course management server;
reading at least one upstream business data record or at least one downstream business data record through the business data course management server according to a current business data type information and a current business data identifier in the business data course search request; and
tracing the at least one upstream business data record or the at least one downstream business data record through the business data course management server according to the business data course search request until data of a target business data type are found.

20. The business data course management method according to claim 19, wherein the business data course search request further comprises a target business data type information and a tracing direction information, and the business data course management server traces and compares the at least one upstream business data record or the at least one downstream business data record according to the target business data type information and the tracing direction information.
